(19) United States
(12) Patent Application Publication
(10) Pub. No.: US 2022/0138886 A1
(43) Pub. Date: May 5, 2022

(54) COGNITVE IDENTIFICATION AND UTILIZATION OF MICRO-HUBS IN A RIDE SHARING ENVIRONMENT

(71) Applicant: International Business Machines Corporation, Armonk, NY (US)

(72) Inventors: Sarbajit K. Rakshit, Kolkata (IN); Shikhar Kwatra, San Jose, CA (US); Michael Bender, Rye Brook, NY (US); Martin G. Keen, Cary, NC (US)

(21) Appl. No.: 16/949,521

(22) Filed: Nov. 2, 2020

(51) Int. Cl. G06Q 50/30; G06Q 30/02; G06N 20/00

(52) U.S. Cl. CPC G06Q 50/30; G06N 20/00; G06Q 30/0203

(57) ABSTRACT

A method, computer system, and a computer program product for ride sharing is provided. The present invention may include requesting destination details from a user. The present invention may include determine one or more potential micro-hubs. The present invention may include ranking the one or more potential micro-hubs by a machine learning model. The present invention may include presenting one or more potential micro-hubs to the user based on the ranking. The present invention may include receiving user feedback.

### BACKGROUND

The present invention relates generally to the field of computing, and more particularly to ridesourcing service systems.

Ridesourcing may allow travelers to request a ride in real-time through an application, which communicates the passenger's location to nearby drivers utilizing a Global Positioning System on a passenger's IoT (Internet of Things) device. Ridesourcing services may enable passengers to share rides with other passengers in exchange for a reduced fare.

Passengers may be matched with other passengers based on similar origins, destination, and time windows.

### SUMMARY

Embodiments of the present invention disclose a method, computer system, and a computer program product for ride sharing. The present invention may include requesting destination details from a user. The present invention may include determine one or more potential micro-hubs. The present invention may include ranking the one or more potential micro-hubs by a machine learning model. The present invention may include presenting one or more potential micro-hubs to the user based on the ranking. The present invention may include receiving user feedback.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for ride sharing according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for ride sharing. As such, the present embodiment has the capacity to improve the technical field of ridesourcing services by utilizing micro-hubs, user preferences, and user feedback to provide improved passenger matching and improved transportation. More specifically, the present invention may include requesting destination details from a user. The present invention may include determining one or more potential micro-hubs. The present invention may include ranking the one or more potential micro-hubs by a machine learning model. The present invention may include presenting one or more potential micro-hubs to the user based on the ranking. The present invention may include receiving user feedback.

As described previously, ridesourcing may allow travelers to request a ride in real-time through an application, which communicates the passenger's location to nearby drivers utilizing a Global Positioning System on a passenger's IoT (Internet of Things) device. Ridesourcing services may enable passengers to share rides with other passengers in exchange for a reduced fare.

Passengers may be matched with other passengers based on similar origins, destination, and time windows.

Therefore, it may be advantageous to, among other things, request destination details from a user, determine one or more potential micro-hubs, rank the one or more potential micro-hubs, present the one or more potential micro-hubs to the user based on ranking, and receive user feedback.

According to at least one embodiment, the present invention may improve ride sharing of passengers by determining one or more micro-hubs, wherein the one or more micro-hubs is determined based on at least the destination details provided by the user and the user preferences. Ride sharing of passengers may be utilized as a venue for productive dialogue between passengers.

According to at least one embodiment, the present invention may improve ridesourcing services by receiving user feedback.

User feedback may be analyzed and leveraged in order to determine one or more potential micro-hubs.

According to at least one embodiment, the present invention may improve ridesourcing systems by ranking one or more potential micro-hubs by a machine learning model. The machine learning model may rank the one or more potential micro-hubs based on an evaluation at least the characteristics of a micro-hub, the user preferences, the destination of the user, and user compatibility.

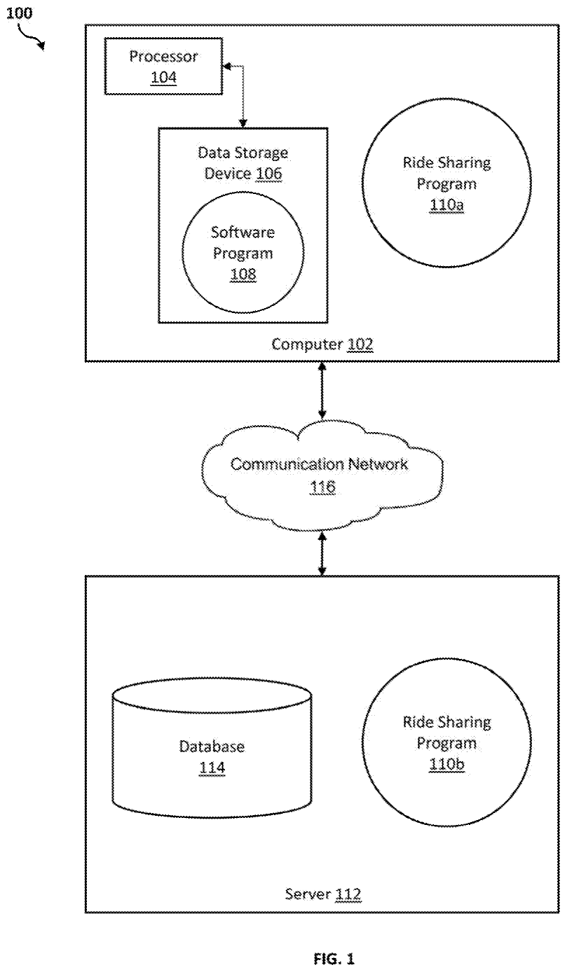

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a ride sharing program 110a. The networked computer environment 100 may also include a server 112 that is enabled to run a ride sharing program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

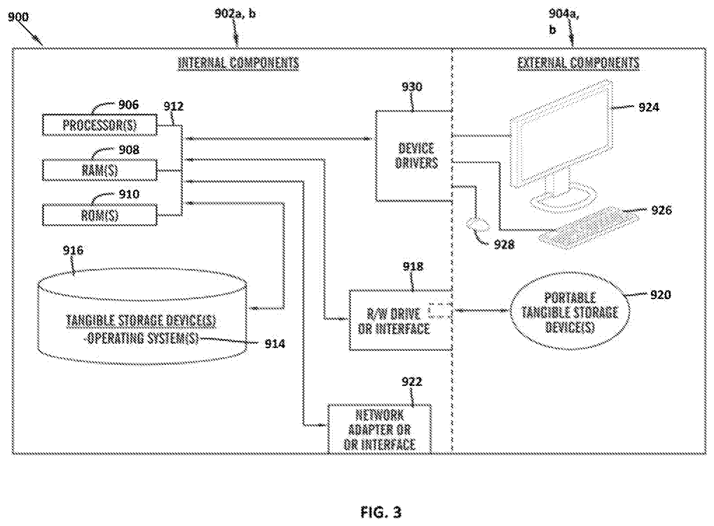

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the ride sharing program 110a, 110b may interact with a database 114 that may be embedded in various storage devices, such as, but not limited to a computer/mobile device 102, a networked server 112, or a cloud storage service.

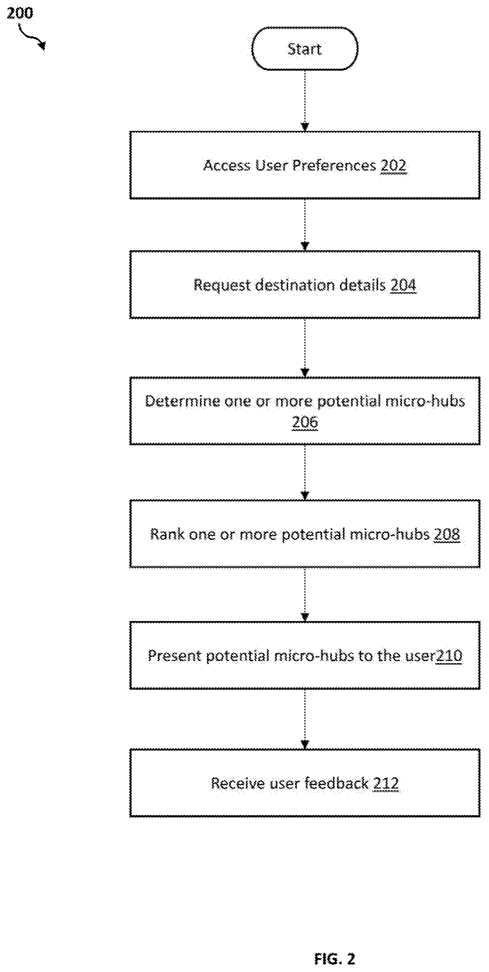

According to the present embodiment, a user using a client computer 102 or a server computer 112 may use the ride sharing program 110a, 110b (respectively) to determine, rank, and present one or more potential micro-hubs to a user. The ride sharing method is explained in more detail below with respect to FIG. 2.

Referring now to FIG. 2, an operational flowchart illustrating the exemplary ride sharing process 200 used by the ride sharing program 110a and 110b (hereinafter ride sharing program 110) according to at least one embodiment is depicted.

At 202, the ride sharing program 110 accesses user preferences. The ride sharing program may 110 be downloaded on the user's smartphone and may have access to the user's personalized user profile (e.g., including the user preferences) within the ride sharing program 110. User preferences may include, but are not limited to including, preferences with respect to micro-hubs, openness to conversation, health conditions, primary residence, permitted access to other applications, amongst others.

The user preferences may be manually inputted by the user (i.e., a ride requesting passenger, ride sharing passenger). The ride sharing program 110 may update the user preferences based on user feedback, which will be explained in more detail with respect to step 212 below.

A micro-hub may be a temporary drop off location utilized by the ride sharing program 110 to coordinate travel of one or more users by more than one vehicle. Preferences with respect to micro-hubs may be updated based on at least feedback received from the user with respect to a micro-hub previously utilized by the user, and feedback received from other users with respect to micro-hubs.

The ride sharing program 110 may utilize biometric data to update user preferences in real-time. Biometric data may include, but is not limited to including, stress levels, sleep patterns, and/or a measure of blood pressure. The ride sharing program 110 may gather biometric data from one or more IoT (Internet of Things) devices, including, but not limited to including, smart phones, wearable devices, amongst others.

For example, the user preferences may indicate a user is open to utilizing micro-hubs and is open to conversation with other passengers. The ride sharing program 110 may determine based on biometric data of the user that the user is experiencing high stress levels and only slept three hours the night before. The ride sharing program 110 may present a prompt (e.g., question, pop-up window) to the user allowing the user to temporarily alter the user preferences to be closed to conversation with other passengers and closed to utilizing micro-hubs based on the biometric data.

At 204, the ride sharing program 110 may request destination details from a user. The ride sharing program 110 may generate a prompt (e.g., question, pop-up window) to request destination details from the user.

The ride sharing program 110 may generate a prompt based on access to other applications on the user's IoT device. Applications on the user's IoT device may include, but are not limited to including, social media applications, calendars, a ticket wallet, train ticket applications, among others. For example, the address input by the user may be for an airport. The ride sharing program 110 may generate a prompt such as “Would you like to update your destination to Terminal 1?” based on the user's ticket wallet application on the user's IoT device.

The ride sharing program 110 may generate a prompt based on an address inputted by the user. For example, the ride sharing program 110 may generate a prompt for the user to specify between a train station and a sports arena if the ride sharing program determines the address input by the user may refer to either.

At 206, the ride sharing program 110 determines one or more potential micro-hubs. The ride sharing program 110 may utilize a machine learning model in determining one or more potential micro-hubs. A micro-hub may be a temporary drop off location utilized by the ride sharing program 110 to coordinate travel of one or more users by more than one vehicle. The ride sharing program 110 may have an established tracking and communication system between all vehicles of a ride sharing network.

The ride sharing program 110 may utilize the established tracking and communication system between all vehicles of the ride sharing network to determine intersecting routes between the user and other vehicles of the ride sharing network based on the destination details provided by the user.

The machine learning model may utilize the intersecting routes determined by the ride sharing program 110 and the user preferences of the ride sharing passengers on the intersecting routes to identify potential micro-hubs that pair compatible users. User compatibility may be determined based on user preferences as well as destination details.

For example, the user may request a ride through the ride sharing program 110. The ride sharing program 110 may utilize the established tracking and communication system between all vehicles of vehicles of the ride sharing network and determine the user may intersect with the 15 other routes. The machine learning model may utilize those 15 routes and determine based on comparing user preferences that the user has a high compatibility with 3 ride sharing passengers that intersect. The machine learning model may determine 3 potential micro-hubs in which the first vehicle will drop off the user in order to pair the compatible users.

At 208, the ride sharing program 110 ranks the one or more potential micro-hubs. The ride sharing program 110 may utilize the machine learning model to determine a score for each of the one or more potential micro-hubs based on the evaluation of at least the characteristics of a micro-hub, user preferences, destination of the user, and the user compatibility. The ride sharing program 110 may rank the one or more potential micro-hubs based on the score determined by the machine learning model.

The characteristics of a micro-hub may include, but are not limited to including, current weather conditions, traffic patterns, crime rates, user feedback, and available amenities.

As described previously with respect to step 202 above the ride sharing program 110 may access user preferences. For example, if a user has a health condition such as an ankle injury the ride sharing program may eliminate micro-hubs that lack seating.

As described previously with respect to step 204 above the ride sharing program 110 may request details on the destination of the user. For example, if more than one user identifies in a prompt that they are going to a particular concert, the ride sharing program 110 may be more likely to determine a micro-hub in which those users share a vehicle.

The ride sharing program 110 may evaluate the one or more potential micro-hubs based on the user compatibility. For example, the ride sharing program may rank a micro-hub higher if the user is open to conversation and would be sharing a vehicle with another user open to conversation.

The ride sharing program 110 may utilize the machine learning model to determine a score for each of the one or more potential micro-hubs based on the evaluation of at least the micro-hub characteristics, user preferences, destination of the user, and the user compatibility.

The ride sharing program 110 may rank the one or more potential micro-hubs based on the score determined by the machine learning model.

At 210, the ride sharing program 110 presents the one or more potential micro-hubs to the user. The ride sharing program 110 may present the one or more potential micro-hubs to the user based on the rank of the one or more potential micro-hubs.

The ride sharing program 110 may provide the score of the one or more potential micro-hubs presented to the user. The ride sharing program 110 may provide details on the score to the user. For example, the ride sharing program 110 may show the user a score was determined due to high user compatibility.

The ride sharing program 110 may present the user with ride details on the one or more potential micro-hubs, such as, but not limited to, estimated fare reduction, estimated time spent at micro-hub, estimated time of arrival at destination, available amenities, feedback from other users, among others.

The user may select one of the potential micro-hubs presented by the ride sharing program 110. The ride sharing program 110 may train the machine learning model based on the micro-hub selected by the user.

For example, the user may select the micro-hub ranked third by ride sharing program 110. The micro-hub ranked third by the ride sharing program 110 may have had high score for user compatibility but other factors may not have scored as well. The machine learning model may weigh user compatibility more in determining a score for a micro-hub in the future.

At 212, the ride sharing program 110 receives user feedback. The ride sharing program 110 may utilize the user feedback to train the machine learning model.

The ride sharing program 110 may utilize the user feedback to update micro-hub characteristics. The user feedback may be stored in a general knowledge corpus. The ride sharing program 110 may utilize the user feedback to update user preferences. The user feedback may be stored in a personal knowledge corpus (e.g., database specific to the user).

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the ride sharing program 110a in client computer 102, and the ride sharing program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the ride sharing program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the ride sharing program 110a in client computer 102 and the ride sharing program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the ride sharing program 110a in client computer 102 and the ride sharing program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

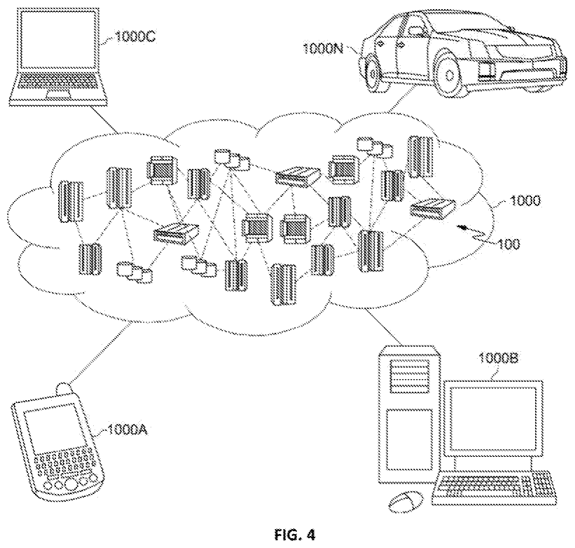

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

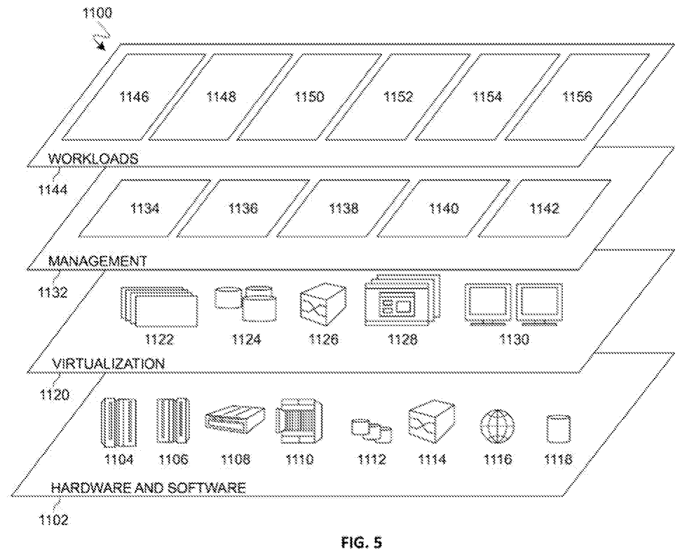

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and ride sharing 1156. A ride sharing program 110a, 110b provides a way to determine, rank, and present one or more potential micro-hubs to a user.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for ride sharing, the method comprising:
requesting destination details from a user;
determining one or more potential micro-hubs, wherein the one or more potential micro-hubs is determined by a machine learning model based on at least the destination details provided by the user and user preferences;
ranking the one or more potential micro-hubs by the machine learning model;
presenting the one or more potential micro-hubs to the user based on the ranking; and
receiving user feedback.

2. The method of claim 1, wherein ranking the one or more potential micro-hubs is based on a score determined by the machine learning model.

3. The method of claim 2, wherein the score determined by the machine learning model is based on an evaluation of at least the characteristics of a micro-hub, the user preferences, a destination of the user, and user compatibility.

4. The method of claim 1, wherein requesting destination details from the user further comprises:
generating a prompt based on an address input by the user.

5. The method of claim 1, wherein presenting the one or more potential micro-hubs to the user further comprises:
providing ride details to the user on each of the one or more potential micro-hubs; and
receiving a response by the user, wherein the response is a selected micro-hub.

6. The method of claim 5, further comprising:
training the machine learning model based on the response by the user.

7. The method of claim 1, further comprising:
training the machine learning model based on the user feedback.

8. A computer system for ride sharing, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
requesting destination details from a user;
determining one or more potential micro-hubs, wherein the one or more potential micro-hubs is determined by a machine learning model based on at least the destination details provided by the user and user preferences;
ranking the one or more potential micro-hubs by the machine learning model;
presenting the one or more potential micro-hubs to the user based on the ranking; and
receiving user feedback.

9. The computer system of claim 8, wherein ranking the one or more potential micro-hubs is based on a score determined by the machine learning model.

10. The computer system of claim 9, wherein the score determined by the machine learning model is based on an evaluation of at least the characteristics of a micro-hub, the user preferences, a destination of the user, and user compatibility.

11. The computer system of claim 1, wherein requesting destination details from the user further comprises:
generating a prompt based on an address input by the user.

12. The computer system of claim 1, wherein presenting the one or more potential micro-hubs to the user further comprises:
providing ride details to the user on each of the one or more potential micro-hubs; and
receiving a response by the user, wherein the response is a selected micro-hub.

13. The computer system of claim 12, further comprising:
training the machine learning model based on the response by the user.

14. The computer system of claim 8, further comprising:
training the machine learning model based on the user feedback.

15. A computer program product for ride sharing, comprising:
one or more non-transitory computer-readable storage media and program instructions stored on at least one of the one or more tangible storage media, the program instructions executable by a processor to cause the processor to perform a method comprising:
requesting destination details from a user;
determining one or more potential micro-hubs, wherein the one or more potential micro-hubs is determined by a machine learning model based on at least the destination details provided by the user and user preferences;
ranking the one or more potential micro-hubs by the machine learning model;
presenting the one or more potential micro-hubs to the user based on the ranking; and
receiving user feedback.

16. The computer program product of claim 15, wherein ranking the one or more potential micro-hubs is based on a score determined by the machine learning model.

17. The computer program product of claim 16, wherein the score determined by the machine learning model is based on an evaluation of at least the characteristics of a micro-hub, the user preferences, a destination of the user, and user compatibility.

18. The computer program product of claim 15, wherein requesting destination details from the user further comprises:
generating a prompt based on an address input by the user.

19. The computer program product of claim 15, wherein presenting the one or more potential micro-hubs to the user further comprises:
providing ride details to the user on each of the one or more potential micro-hubs; and
receiving a response by the user, wherein the response is a selected micro-hub.

20. The computer program product of claim 19, further comprising:
training the machine learning model based on the response by the user.
